(19) United States
(12) Patent Application Publication
(10) Pub. No.: US 2018/0174174 A1
(43) Pub. Date: Jun. 21, 2018

(54) TREND-BASED DATA ANLYSIS

(71) Applicant: SAP SE, Walldorf (DE)

(72) Inventor: Volodymyr Vasyutynskyy, Dresden (DE)

(21) Appl. No.: 15/383,133

(22) Filed: Dec. 19, 2016

(51) Int. Cl. G06Q 30/02; G06Q 10/06

(52) U.S. Cl. CPC G06Q 30/0206; G06Q 10/067

(57) ABSTRACT

Methods, systems, and computer program products for cost estimation are described. A cost structure for a product is obtained from a database and a price trend model for one or more items of the cost structure is obtained from a price trend model repository of the database. An item cost for each of the one or more items of the cost structure are computed using the price trend model. A cost of the product based on the item costs is computed.

### FIELD

The present disclosure relates generally to data processing. In an example embodiment, the disclosure relates to trend-based data analysis.

### BACKGROUND

Data analysis, such as product costing, or estimating the costs of products for past, present, and future time periods, may be crucial for the success of a company. Conventionally, cost estimates are generated from databases of historical price information. The cost for each item of a product is estimated based on the historical price information, and the individual costs are rolled up to derive the overall cost estimate of the product. In certain instances, experts, such as purchasing managers and the like, may estimate the cost of an item when historical data is not available.

### BRIEF DESCRIPTION OF DRAWINGS

The present disclosure is illustrated by way of example and not limitation in the figures of the accompanying drawings, in which like references indicate similar elements and in which:

FIG. 1 is an example data structure in the example form of a cost structure for a product, in accordance with an example embodiment;

FIG. 2A is a diagram of an example architecture for estimating product costs, in accordance with an example embodiment;

FIG. 2B is a block diagram of an example apparatus for implementing the product costing platform, in accordance with an example embodiment;

FIG. 3 is a diagram of an example workflow for estimating product costs, in accordance with an example embodiment;

FIG. 4 shows an example workflow of an extractor, in accordance with an example embodiment;

FIG. 5 shows a graphical representation of the historical data obtained by a historical analysis extractor, in accordance with an example embodiment;

FIG. 6A is a high-level representation of a unified data model for cost estimation, in accordance with an example embodiment;

FIGS. 6B-6E show graphical representations of the calculated cost for an item using a selected price trend model, in accordance with an example embodiment;

FIG. 7 is a flowchart for an example method for estimating the costs of the items in a cost structure, in accordance with an example embodiment;

FIG. 8 shows a flowchart for an example method for estimating the costs of a product, in accordance with an example embodiment;

FIG. 9 shows a graphical representation of the calculated cost for a whole product, in accordance with an example embodiment;

FIG. 10 shows an example user interface for obtaining cost estimates of a product, in accordance with an example embodiment;

FIG. 11 is a block diagram illustrating a mobile device, according to an example embodiment; and

FIG. 12 is a block diagram of a computer processing system within which a set of instructions may be executed for causing a computer to perform any one or more of the methodologies discussed herein.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Generally, methods, systems, apparatus, and computer program products for performing data analysis, such as estimating product costs, are described. Product costing, or estimating the costs of products for past, present, and future time periods, may be crucial for the success of a company. It plays, for example, an important role in highly competitive industries, like the automotive and high-technology industries, where several per-cents of costs may result in success or failure of a product, a company, or both. Traditionally, product costing may be based on a cost structure. A cost structure includes sub-items of different item types (such as materials, activities, processes, and the like) used to manufacture the product. Complex products may have a cost structure containing thousands of items.

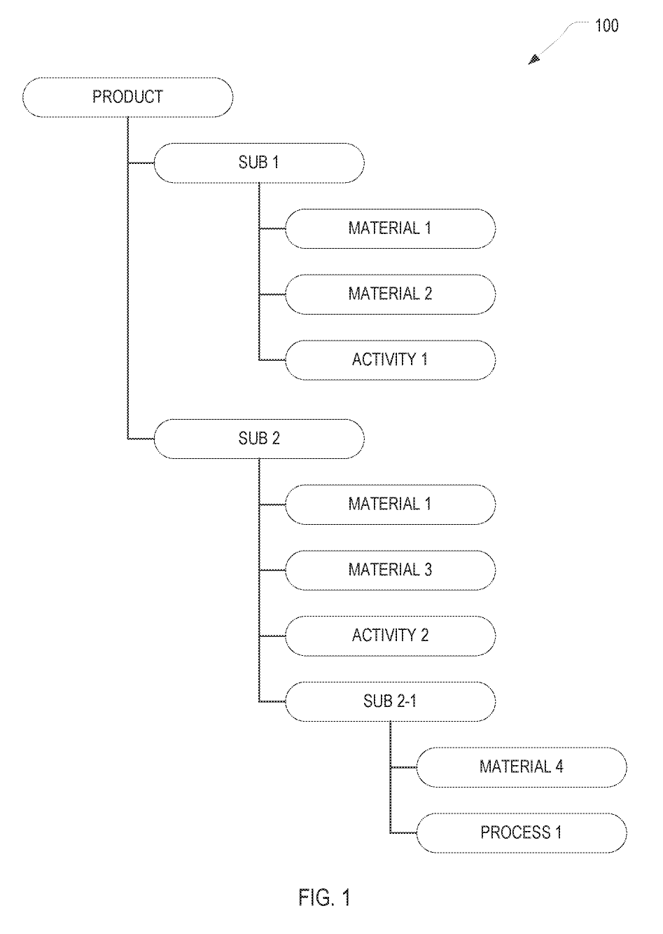

In one example embodiment, product costing includes estimating the costs of a product for a past, present, or future time period, or any combination thereof. The product costing may be based on a defined product structure, cost structure, or both. A product structure defines the materials, chemicals, devices, components, sub-assemblies, and the like that are used to manufacture the product. A cost structure defines the items and sub-items that are used to manufacture the product, including different item types, such as materials, activities, processes, and the like. FIG. 1 is an example data structure in the example form of a cost structure 100 for a product, in accordance with an example embodiment. A material may be a chemical, a compound, a device, a component, a sub-assembly, and the like. A process may be, for example, a preparation task, a manufacturing process, a chemical process (such as annealing), and the like. An activity may be a handling task, a shipping task, and the like.

Each product may have one to thousands of associated items. Each item is associated with corresponding master data, such as prices, price validity information, and the like. The prices may vary over time. Based on the cost structure and the master data, the costs of the final product may be calculated. The components of the product cost, such as material costs, manufacturing costs, and the like, may also be calculated. The cost information may be used by the users of product costing systems (such as controllers) for making production planning decisions, deriving different key performance indicators (such as profit, profit margin, and labor costs), and the like.

Historically, only rudimentary techniques were available to consider price trends (price changes over time) for an item. For example, the prices could be entered manually for different past and future periods of times (if available). In many cases, information about future prices may not be available for some or all item types. Thus, in one example embodiment, information indicative of a price trend is collected, analyzed, managed, and used for product cost calculations. The price trend information may be collected from a variety of sources, compiled, and stored as a price trend model (such as a time series model) in a repository during a learning phase. The price trend model(s) may be used to estimate the prices of a product for past, present, or future time periods during an execution phase. The use of the price trend model allows for a reduced memory footprint and accelerated cost estimations.

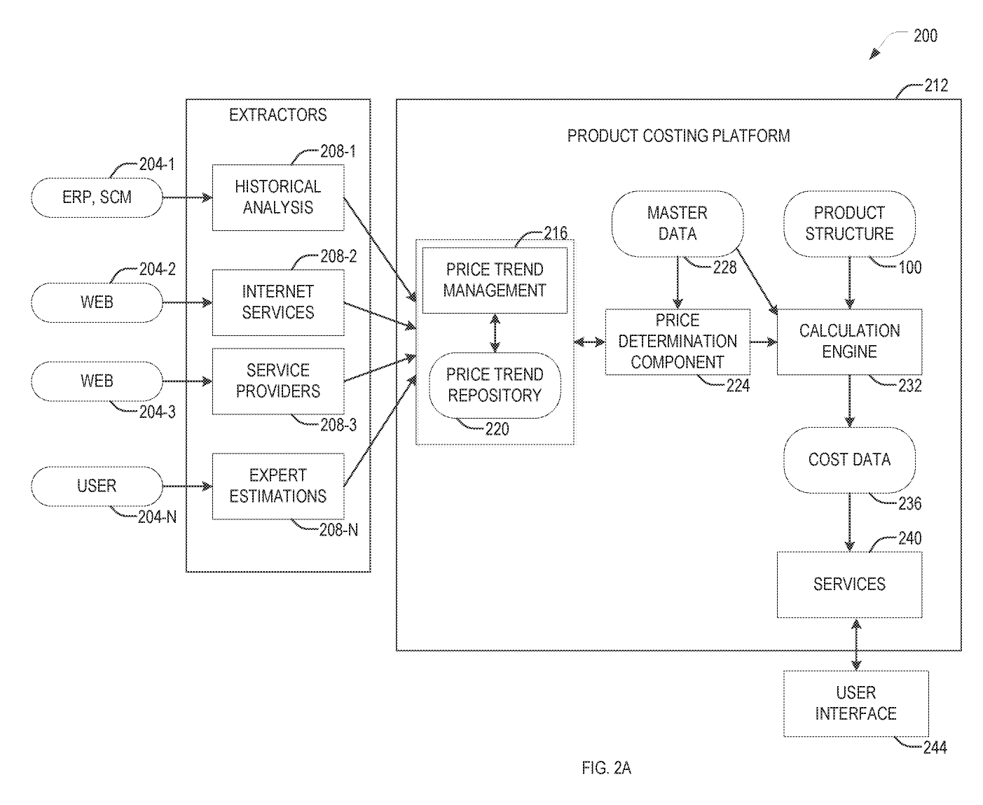

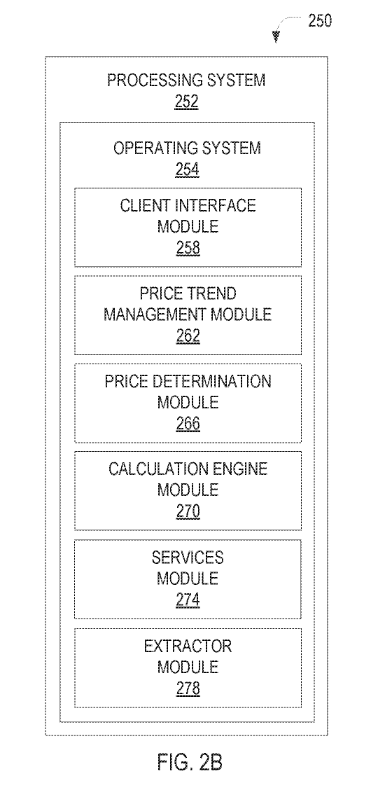

FIG. 2A is a diagram of an example architecture 200 for estimating product costs, in accordance with an example embodiment. In one example embodiment, data sources 204-1, . . . 204-N (collectively known as data sources 204 herein) are accessed to obtain pricing information, such as information indicative of price trends for an item of a product. A data source 204 may be an enterprise resource planning (ERP) system, a supply chain management (SCM) system, a web site, and the like. The data source 204 may contain, for example, the price of an item, such as a component of a product or a process used to manufacture the product, for specified periods of time. In one example embodiment, the data source 204 (such as data source 204-N) may be a user such as a market analyst or other expert, who provides expert estimations for a cost of a product item.

A set of extractors 208-1, . . . 208-N (collectively known as extractors 208 herein) collect and deliver the trend data to the price trend management component 216 of the product costing platform 212. The trend data may be in the form of a data model, such as a price trend model. For example, a historical analysis extractor 208-1 extracts historical cost pricing information from, for example, an ERP system and generates a data model that can be used to estimate a cost for a corresponding item of a product. An Internet services extractor 208-2 extracts cost pricing information from a web site or other Internet entity and generates a data model that can be used to estimate a cost for the corresponding product item. A service provider extractor 208-3 extracts cost pricing information from, for example, a third-party or other service provider, and generates a data model that can be used to estimate a cost for the corresponding product item. An expert estimations extractor 208-N receives cost pricing information from the user 204-N, such as a market analyst or other expert, and generates a data model that can be used to estimate a cost for the corresponding product item. The data models from the extractors 208 are persisted to a price trend repository 220 via the price trend management component 216.

As described above, a purpose of the extractors 208 is to derive the data models from a corresponding data source 204. In one example embodiment, the historical analysis extractor 208-1 develops price trend information based on the historical prices for the same or similar items using the methods of time series analysis. For example, polynomial interpolation (see, for example, https://en.wikipedia.org/wiki/Polynomial_interpolation) may be used to generate a data model that estimates prices based on historical information. The historical price information for some materials may be obtained from public resources, like stock or commodity exchange portals. The Internet services extractor 208-2 develops price trend information based on the historical prices from these sources for the same or similar products using the methods of time series analysis.

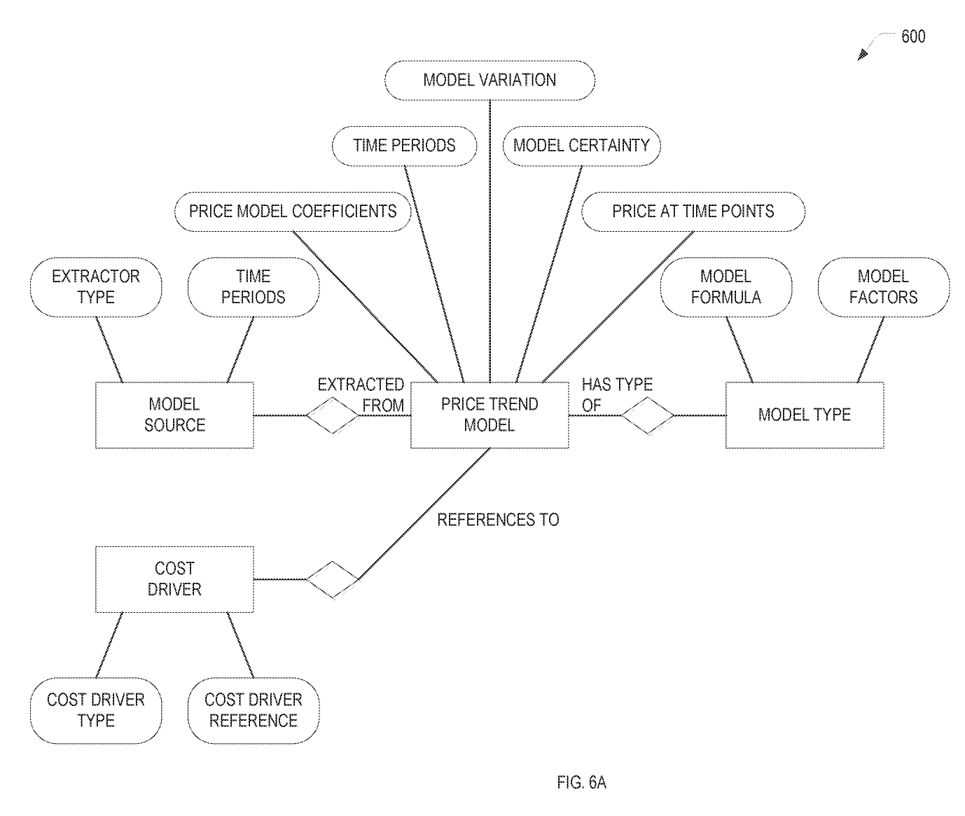

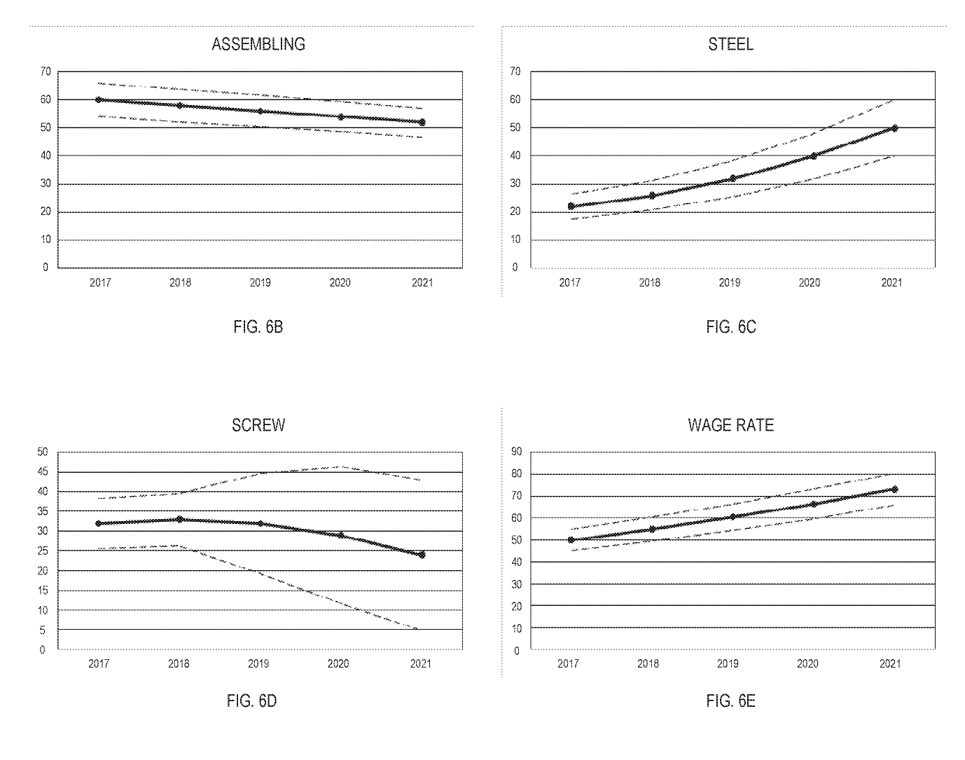

The service providers extractor 208-3 obtains pricing information from data sources, such as third parties, that are specialized on extracting such information, such as PCPartPicker (see, https://pcpartpicker.com). The information from these data sources can be extracted using techniques like web crawling or feed requests, and a data model can be generated from the obtained information. In one example embodiment, the pricing information obtained from the extractor 208 is already in the form of a data model. If the obtained data model is not compatible with the architecture 200, the data model obtained from the extractor 208 may be used as the basis for generating a data model compatible with a unified data model, as described more fully below by way of example in conjunction with FIG. 6A.

The expert estimations extractor 208-N obtains pricing information from experts, such as a purchasing agent who manually maintains a price model based on their experience, contract history, market situation, and the like. If raw pricing data is obtained, it may be used to compute the data model. If a manually maintained price model is obtained, it may be used as the basis for generating a data model compatible with the unified data model of FIG. 6A.

The price trend information obtained from the extractors 208 is consolidated in the price trend repository 220 using a unified interface based on a unified data model, described more fully below by way of example in conjunction with FIG. 6A. Each extractor 208 can be triggered to provide pricing information periodically, in response to a specific event (such as a user action or a costing request), and the like. The extractors 208 may execute sequentially, in parallel, or both.

The price trend repository 220 contains the price trend data in the form, for example, of the unified data model, such as a time-based model that may be used to estimate the costs for the product items, groups of product items, and the like. Since each price trend model may be characterized by just a few parameters, the memory footprint for the price trend model remains relatively small (in comparison, for example, to a memory footprint that contains the entire history of prices for an item). In one example embodiment, the price trend models may be stored in a legacy data storage system, such as the data storage system that maintains the master data 228.

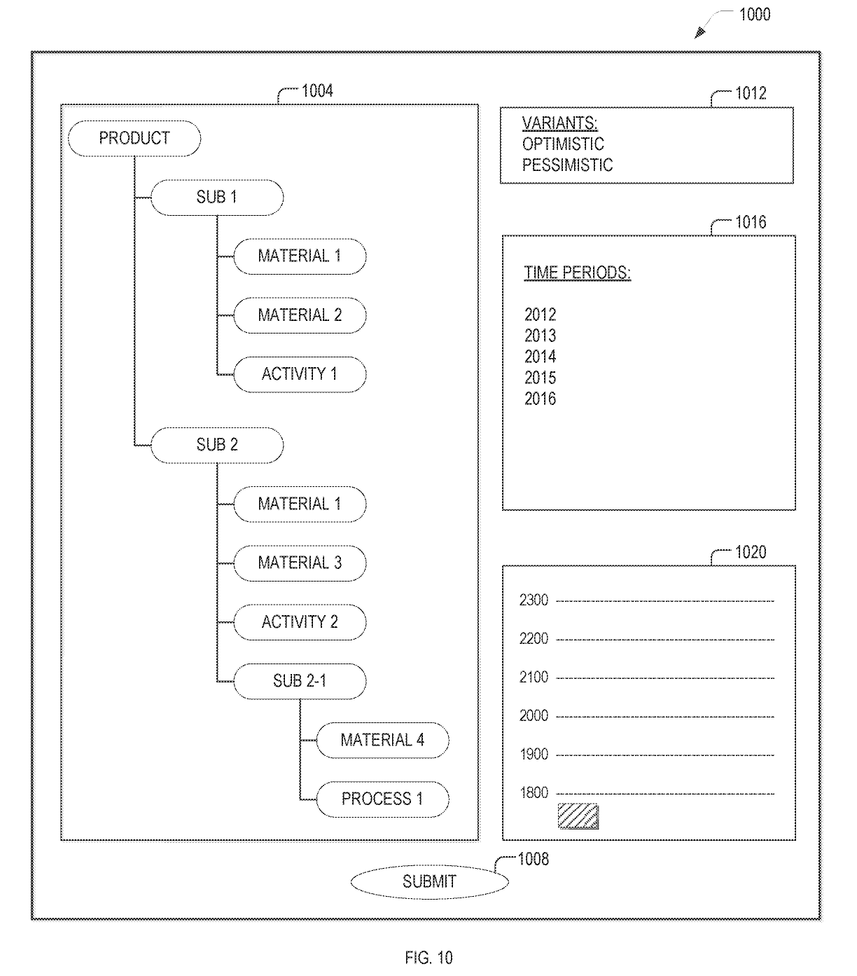

The price trend data is managed by the price trend management component 216. The price trend management component 216 persists price trend data obtained from the extractors 208 to, for example, the price trend repository 220 and provides access to the price trend data for other components, such as the price determination component 224. The price determination component 224 calculates prices for specified items for specified time periods based on the price trend models and a variety of algorithm settings, as described more fully below by way of example. The calculation engine 232 determines the cost of the whole product based on the costs calculated by the price determination component 224. The cost data 236, such as the cost of the whole product, the individual item costs calculated by the price determination component 224, and the like, are provided to the services module 240. A user interface 244 may obtain the cost data 236 via the services module 240, and may also request the calculation of a cost estimate for a particular product or item via the services module 240, as described more fully below by way of example in conjunction with FIG. 10.

FIG. 2B is a block diagram of an example apparatus 250 for implementing the product costing platform 212, in accordance with an example embodiment. The apparatus 250 is shown to include a processing system 252 that may be implemented on a client or other processing device, and that includes an operating system 254 for executing software instructions. In one example embodiment, the extractors 208 are integrated into the apparatus 250 (as illustrated in FIG. 2B). In accordance with an example embodiment, the apparatus 250 may include a client interface module 258, a price trend management module 262, a price determination module 266, a calculation engine module 270, a services module 274, and an extractor module 278.

The client interface module 258 provides an interface for users to specify the data sources 204 available to the extractors 208 and to input particular data models. The client interface module 258 may submit a request for a cost estimate for a product, a product item, or both, to the services module 274, and may obtain the cost estimates generated by the price determination module 266 and the calculation engine module 270 via the services module 274.

The price trend management module 262 implements the price trend management component 216, and the price determination module 266 implements the price determination component 224. The price determination module 266 determines the costs of items for a specified time period and provides the costs to the calculation engine module 270 of the product costing platform 212. The calculation engine module 270 calculates the overall cost for the product based on the costs determined by the price determination module 266, the cost structure 100, and the master data 228.

The services module 240 provides an interface for the client interface module 258 to request a cost estimate and to obtain the cost estimates generated by the price determination module 266 and the calculation engine module 270.

The extractor module 278 implements one or more of the extractors 208, such as the historical analysis extractor 208-1, the Internet services extractor 208-2, the service provider extractor 208-3, and the expert estimations extractor 208-N. The extractor module 278 collects pricing information (including data models) and derives data models based on pricing information obtained from the data sources 204, and delivers the data models to the price trend management component 216 of the product costing platform 212. In one example embodiment, the extractor module 278 may obtain a data model directly from one of the data sources 204.

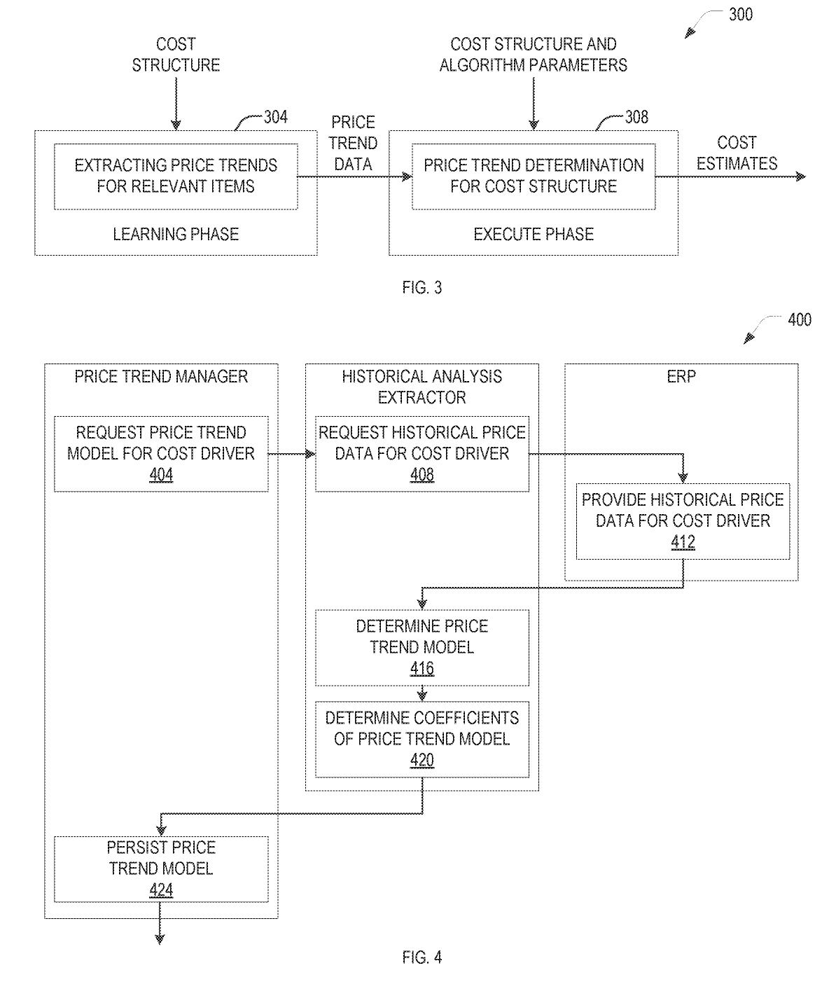

FIG. 3 is a diagram of an example workflow 300 for estimating product costs, in accordance with an example embodiment. The workflow 300 consists of two phases: a learning phase 304 and an execution phase 308.

During the learning phase 304, the cost structure 100 for the product is provided to the product costing platform 212. The price trend information is obtained from the data sources 204 using the extractors 208 and, according to the settings for given items or item types, the data models are obtained or generated, and stored in the price trend repository 220. The relationships/entities describing the cost drivers, as described more fully below by way of example, and the rules for determining the data models to be used for determining the item costs, are defined during the learning phase 304. In one example embodiment, pricing information known to, for example, a manufacturer for a set of materials that are used in the manufacture of a product(s) may be provided to the product costing platform 212. The pricing information may be provided in response to a change to the pricing information, periodically, at a scheduled time, and the like.

During the execution phase 308, the costs for items identified in the cost structure 100 are determined based on the given parameters and the price trend information (e.g., the data models) obtained during the learning phase 304. The price determination component 224 determines the costs of items for the specified time period(s) and provides the item costs to the calculation engine 232 of the product costing platform 212. The calculation engine 232 then calculates the estimated cost data 236 for the product based on the item costs determined by the price determination component 224, the cost structure 100, and the master data 228.

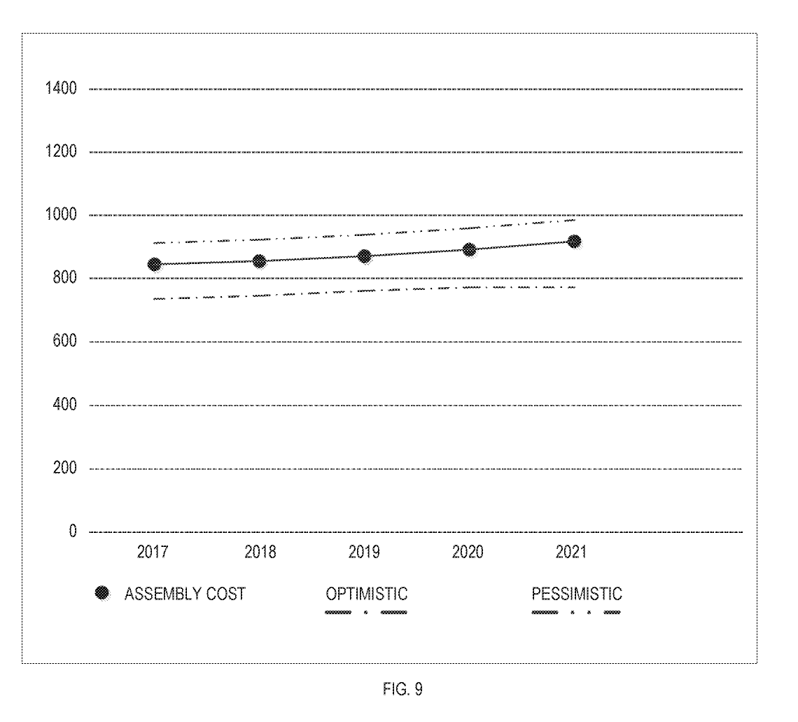

For example, a basic cost calculation for a pump casing product may include the following items:
steel (a material) weighing 20 kilograms
pouring of the casing (an activity) lasting 80 minutes
screws (a material) of four pieces
assembly (an activity) lasting 65 minutes
   The production phase of the pump casing product is planned to start on Jan. 1, 2017 and last for four years. The purpose of the cost estimation is to forecast the cost for the final product in each year of production (2017-2020). The cost estimate derived by the calculation engine 232 is described more fully below by way of example in conjunction with FIG. 9.

FIG. 4 shows an example workflow 400 of the extractor 208, in accordance with an example embodiment. In the example of FIG. 4, due to the absence of a valid data model for the item under consideration, the price trend management component 216 issues a request for a price trend model for a specified cost driver (such as the specified product item, assembly activity, and the like) to, for example, the historical analysis extractor 208-1 (operation 404). The extractor(s) 208 are selected based on the settings provided, for example, by a user. The settings may be used to filter the available extractors 208 and include:
target certainty
time parameters (such as specified time periods for the cost estimates)
selected cost drivers
preferred data sources (such as historical data, human experts, and the like)
target variants of costs (such as optimistic, pessimistic, and the like)
   The extractors 208 having characteristics that match the settings, such as extractors 208 that provide the requested variants, satisfy the target certainty, are compatible with the requested data sources 204, meet company or departmental rules, and the like, may be selected.

The selected extractor 208 requests the pricing information, such as the historical data, for the specified cost driver for a specified time period (such as, for one or more calendar years) from, for example, an ERP system (operation 408). The ERP system retrieves the pricing information and provides the requested historical data to the historical analysis extractor 208-1 (operation 412).

The historical analysis extractor 208-1 determines the appropriate price trend model based on the historical data obtained from the data source 104-1 (operation 416). The historical analysis extractor 208-1 determines the coefficients for the selected price trend model, and the price trend model and corresponding coefficients are provided to the price trend management component 216 (operation 420). The price trend management component 216 persists the price trend model and corresponding coefficients to the price trend repository 220 (operation 424).

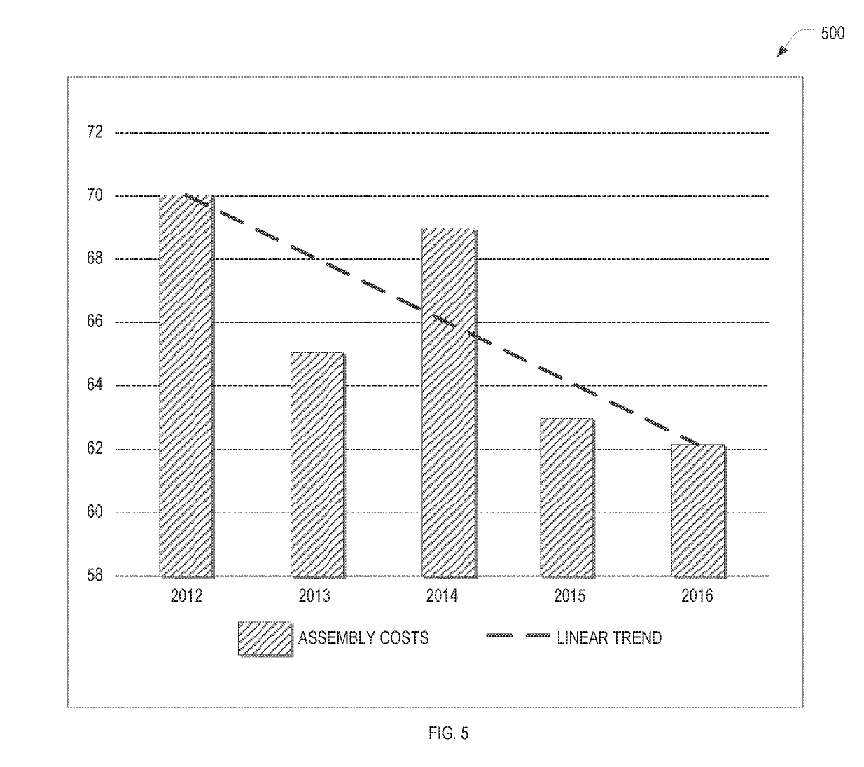

FIG. 5 shows a graphical representation 500 of the historical data obtained by the historical analysis extractor 208-1, in accordance with an example embodiment. As illustrated in FIG. 5, the assembly cost is shown for each year of the specified time period (2012-2016) along with a linear approximation of the assembly cost over the specified five-year period.

In one example embodiment, the following properties of the price trend model are saved in the price trend repository 220:
cost driver type (such as, assembly)
model type (such as, simple inflation model)
model coefficients (such as, a=−2.1, b=70)
model variation (such as, var=3.2)
model source (such as, historical data from ERP system)
   In the above example, the model type is a linear approximation defined as yᵢ=a*tᵢ+b, where yᵢ is the price in the i-th time bucket, tᵢ is the time bucket number, and a and b are model coefficients. The extracted model can be used not only in the current cost calculation, but also in the cost calculations of other products that contain the same assembly activity.

FIG. 6A is a high-level representation of a unified data model 600 for cost estimation, in accordance with an example embodiment. The price trend model of the unified data model 600 is stored as a time-series model, which describes the development of prices over time (depending on different factors, such as specified time periods, external factors, and internal factors) for the corresponding cost driver (cost item). External factors include items such as strikes, weather issues, governmental regulations, worldwide material shortages, holiday shutdowns, and the like. Internal factors include factors such as company rules, departmental rules, and the like. A cost driver can be an item of a cost structure, a group of items of a cost structure, a property of an item, and the like. For example, if a price for an item is set to follow the simple inflation model of a 3% increase per year, then the price can be described by the model of compound interest:

pᵢ(k)=pᵢ(0)*(1+aᵢ)^{k},

where pᵢ(k) is the price of item i in the time moment k, pᵢ(0) is the price in the initial moment (such as the current price), and aᵢ is the price increase coefficient (such as 0.03=3%). A property of an item can be, for example, a vendor of an item or a vendor of a set of items, and the cost driver is a price trend for the vendor that characterizes all of the vendor's items.

The price trend model may contain the following information:
type of price trend model (compound interest, linear model, and the like)
model coefficients (such as price increase coefficient aᵢ)
prices to the specific time moments (such as p(0))
information on specified time periods
certainty of the model
other fields (such as the source of the model, user comments, and the like)

The prices to the specific time moments may also be available in the price trend repository 220 or may be replicated from the master data 228. The certainty of the model can be described by grades, such as from a grade of 1 (completely uncertain estimation) to a grade of 10 (completely certain, for example, as confirmed by a corresponding purchase contract). The certainty of the model can be defined based on the estimations of experts or the source of the model. For example, the prices from confirmed contracts have a certainty of 10 and the prices extracted from Internet services may have a certainty of 6. The information on specified time periods may indicate, for example, if the time period is a month, a quarter (a three-month time period), a year, and the like. The certainty may be set manually by a user, be obtained from the data source 204, be automatically provided by a computerized evaluation of the data source 204 (such as the historical certainty demonstrated by the data source 204), and the like.

The data models can be defined for different types of cost drivers, such as a single item, a group of items, a part of an item (such as a material, a production activity, and the like), an overhead cost, and the like. This can be mirrored in the corresponding relationships/entities describing the cost drivers, which may be, for example:
1) Item-Model entity—
   a model defined for one or more specified items,
   such as for the material “left casing”
2) Group of Item-Model entity—
   a model defined for a group of items,
   such as for the materials in a group of “casings”
3) Type of Item-Model entity—
   a model defined for all items of a certain type,
   such as for all activities
4) General model entity—
   a model defined for all items (if no further precise information is available).

A variety of data model types may be utilized to estimate the cost of an item. FIGS. 6B-6E show graphical representations of the calculated cost for an item using a selected example price trend model, in accordance with an example embodiment.

Linear Model with Constant Variance

FIG. 6B shows a graphical representation of the calculated cost for an item following a linear model with constant variance, in accordance with an example embodiment. If a price for an item is set to follow a linear model with constant variance, then the price can be described by the formula:

pᵢ(k)=pᵢ(0)*(1+a_{i,1}*k)

where pᵢ(k) is the price of item i in the time moment k, pᵢ(0) is the price in the initial moment (e.g., the current price), and a_{i,1} is the price increase coefficient for item i (e.g., 0.03=3%). The variance may be defined by:

vᵢ(k)=pᵢ(0)*d_{i,0}

where vᵢ(k) is the variance of price for item i in the time moment k, and d_{i,0} is the variance coefficient for item i. The estimation of maximal price for item i in the time moment k (upper dashed line in FIG. 6B) is calculated as p_{i, max}(k)=pᵢ(k)+vᵢ(k). The estimation of minimal price for item i in the time moment k (lower dashed line in FIG. 6B) is calculated as p_{i, min}(k)=p₁(k)−vᵢ(k).
Quadratic Model with Linear Increasing Variance

FIG. 6C shows a graphical representation of the calculated cost for an item following a quadratic model with linear increasing variance, in accordance with an example embodiment. If a price for an item is set to follow a quadratic model with linear increasing variance, then the price can be described by the formula:

pᵢ(k)=pᵢ(0)*(1+a_{i,2}*k²+a_{i,1}*k)

where a_{i,2} and a_{i,1} are the price model coefficients for item i. The variance may be defined by:

vᵢ(k)=pᵢ(0)*d_{i,0}*(1+d_{i,1}*k)

where d_{i,0} and d_{i,1} are the variance coefficients for item i.
Quadratic Model with Quadratic Increasing Variance

FIG. 6D shows a graphical representation of the calculated cost for an item following a quadratic model with quadratic increasing variance, in accordance with an example embodiment. If a price for an item is set to follow a quadratic model with quadratic increasing variance, then the price can be described by the formula:

pᵢ(k)=pᵢ(0)*(1+a_{i,2}*k²+a_{i,1}*k)

where a_{i,2} and a_{i,1} are the price model coefficients for item i. The variance may be defined by:

vᵢ(k)=pᵢ(0)*d_{i,0}*(1+d_{i,2}*k²+d_{i,1}*k)

where d_{i,0}, d_{i,1} and d_{i,2} are the variance coefficients for item i.
Model of Compound Interest with Constant Variance

FIG. 6E shows a graphical representation of the calculated cost for an item following a model of compound interest with constant variance, in accordance with an example embodiment. If a price for an item is set to follow a model of compound interest with constant variance, then the price can be described by the formula:

pᵢ(k)=pᵢ(0)*(1+aᵢ)^{k}

where aᵢ is the price increase coefficient (e.g., 0.03=3%).

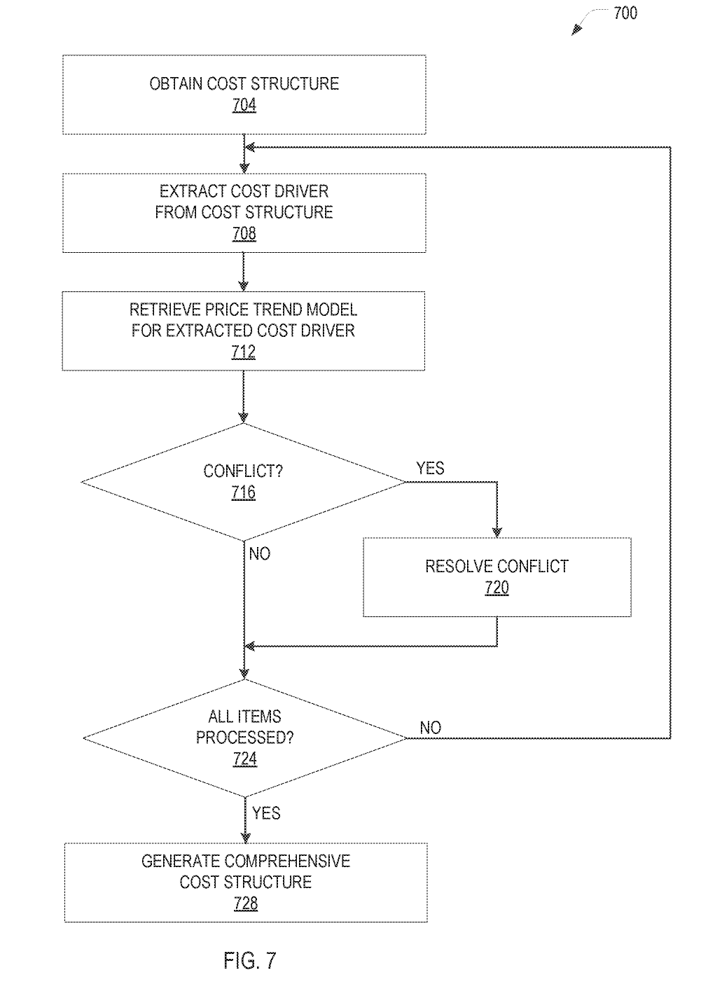

FIG. 7 is a flowchart for an example method 700 for estimating the costs of the items in a cost structure, in accordance with an example embodiment. The method 700 may be initiated by a user, may be a part of a product costing process triggered and parameterized by the calculation engine 232, and the like. The inputs of the method 700 are the cost structure 100 of the product, the master data 228 of the product items, and the price trend models of the product items. In one example embodiment, the price determination component 224 selects the data models based on the available models and the user settings, and calculates the price(s) of each item of the cost structure 100 for the specified period(s) of time based on the formulas of the data models. For example, the data models that have characteristics that match the specified settings, such as data models that provide the requested variants and can handle the requested data sources 204, and the like, may be selected. The calculation engine 232 then calculates the cost of the whole product based on the prices of each item of the product structure.

In one example embodiment, the parameters of the method 700 are set based on user preferences, manual settings, department or company-wide settings, and the like. The settings may include:
target certainty of the algorithm
time parameters (such as specified time periods for the cost estimates)
selected cost drivers
preferred trend data sources (such as historical data, human experts, and the like)
target variants of costs (such as optimistic, pessimistic, and the like)
rules for solving conflicts
   The selected cost drivers are the items of the cost structure 100 that will be used in the item cost calculations. By default, all items of the cost structure 100 are used. For other (non-selected) cost drivers, the standard price definition methods of the product costing platform may be used. The standard price definitions may be defined prices that are constant over time, prices that are predefined and vary over time, and the like. The standard price definitions may be manually set by a user.

The time parameters may be, for example, the start date and end date of the production of the product, the time step (such as month, quarter, year), and the like. A target variant of costs is, for example, optimistic, average, pessimistic, and the like. The variants may be defined based on the variance of a data model, the desired certainty, and the like. For example, an optimistic variant may be defined as plus or minus sigma and a pessimistic variant may be defined as plus or minus three sigma. A rule for solving a conflict is, for example, a rule for selecting a price trend model in the case where several price trend models are available for the same item. For example, the settings defined above may be used to filter the data models that may be used. Thus, a data model that is characterized by a specified certainty or that can process data from a specified data source 204 (such as that can process historical data) can be selected (if a plurality of data models are available).

### Determination of Price Trend Models and Comprehensive Cost Structure

In one example embodiment, the cost structure 100 for the product is obtained (operation 704). The cost structure 100 may be obtained from a user (as described more fully below by way of example in conjunction with FIG. 10), a customer order, engineering documents, and the like. In one example embodiment, a cost structure 100 may be retrieved from an archival system. The first cost driver is extracted from the cost structure 100 (operation 708). Based on the user settings and rules for the price trend models, a data model is selected, retrieved from the price trend repository 220, and assigned for the extracted cost driver (operation 712). A test is performed to determine if there is a data model conflict (operation 716). If there is a conflict, the conflict is resolved (operation 720). For example, if multiple price trend models are available for the cost driver, one of the price trend models is selected.

When all conflicts have been resolved, or when no conflict is found at operation 716, a test is performed to determine if all product items of the cost structure 100 have been processed (operation 724). If there is a product item of the cost structure 100 that has not been processed, the method 700 proceeds with operation 708 (where the next cost driver is extracted from the cost structure 100). If all product items of the cost structure 100 have been processed, a comprehensive cost structure that includes the selected price trend models is generated (operation 728).

### Product Cost Calculation

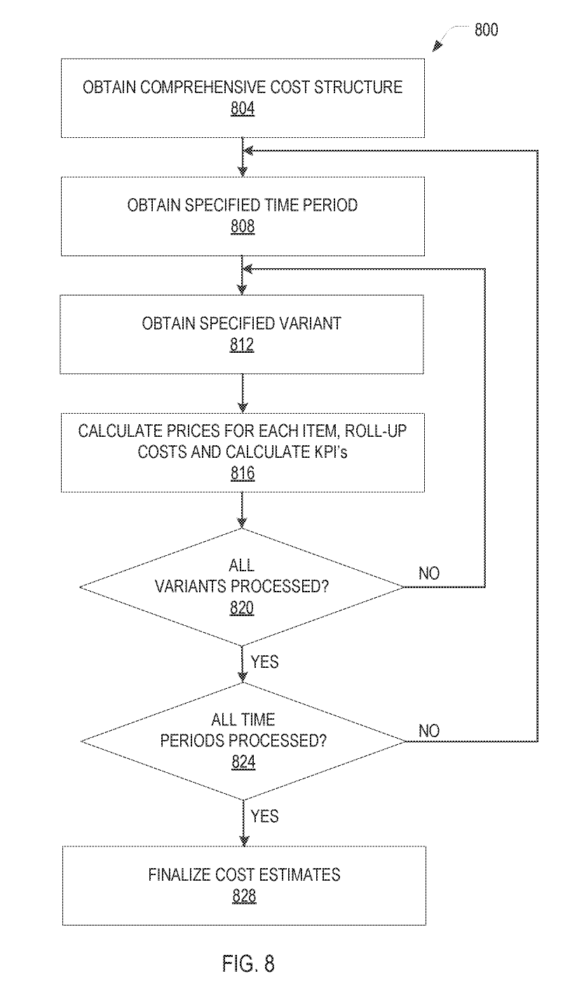

FIG. 8 shows a flowchart for an example method 800 for estimating the costs of a product, in accordance with an example embodiment. In one example embodiment, the cost structure 100 for the product is obtained (operation 804). For example, the cost structure 100 may be obtained from the master data 228, from a user via a user interface (as described more fully below by way of example in conjunction with FIG. 10), and the like. The first time period for computing the product and product item costs is obtained (operation 808) and the first variant for computing the product and product item costs is obtained (operation 812). For example, the time period and variant may be obtained from a user via a user interface, as described more fully below by way of example in conjunction with FIG. 10.

The prices for each product item of the cost structure 100 are calculated for the specified time period and specified variant based on the selected price trend models and the master data 228 for the item. The results of the price determination are used by the calculation engine 232 for the calculation of the whole product cost, which calculates the product cost by a rollup of the individual item costs according to the item types, starting with low-level items and proceeding to higher-level items (operation 816). For example, as defined in the cost structure 100, process 1 and material 4 may be calculated first and then rolled up to calculate sub-item 2-1.

In one example embodiment, the Key Performance Indicators (KPIs) are also calculated, which are used for the analysis of the cost estimates. The KPIs may include total costs per item, total sales, profit margin, uncertainty of calculation results, and the like. The results of the cost calculation can be used for different cost controlling tasks, including lifecycle optimization, making production or sales decisions, comparing different variants, and the like.

A test is performed to determine if all variants specified for the pending time period have been processed (operation 820). If all variants specified for the pending time period have not been processed, the method 800 proceeds with operation 812 where the next variant is obtained; otherwise, the method 800 proceeds with operation 824.

During operation 824, a test is performed to determine if all specified time periods have been processed. If all specified time periods have not been processed, the method 800 proceeds with operation 808 where the next time period is obtained; otherwise, the method 800 proceeds with operation 828. During operation 828, the calculation engine 232 formats and provides the cost data 236 to the services module 240.

### Example

FIG. 9 shows a graphical representation of the calculated cost for a whole product, in accordance with an example embodiment. Both optimistic and pessimistic scenarios are calculated using the model variation (see dashed lines). After that, the overall costs for the product are calculated as a weighted sum of the items based on the cost structure 100. The costs of the whole product and its component items may be estimated for each year of production. For example, the price for assembling in year 2017 is calculated as y=−2,1*6+70, where 6 corresponds to 2017 (6^{th} year or model). Graphical representations of the calculated cost for individual product items may be similarly generated and displayed.

The detail grade of the trend analysis can be easily varied. For example, a rough estimate can initially be performed and a detailed estimate can be performed in a pre-production phase of the product development. The rough estimate may be a yearly estimate calculated over a period of three years using the Group of Item-Model entities and the detailed estimation may be a monthly estimate calculated over a period often years using the Item-Model entities. A plurality of estimates may be calculated for different variants, certainties, and the like.

FIG. 10 shows an example user interface 1000 for obtaining cost estimates of a product, in accordance with an example embodiment. A cost structure 100 may be entered in a cost structure window 1004. The cost structure 100 may be entered in textual form or graphical form (as illustrated in FIG. 10). The selected variants may be entered or selected via a variant window 1012 and the selected time periods may be entered or selected via a time window 1016. Once the cost structure 100, variants (if any), and time period(s) have been entered, a submit button 1008 may be selected to initiate the calculation and display of the cost estimates. A graphical representation of the calculated cost for the whole product, such as the graphical representation of FIG. 9, may be displayed in results window 1020.

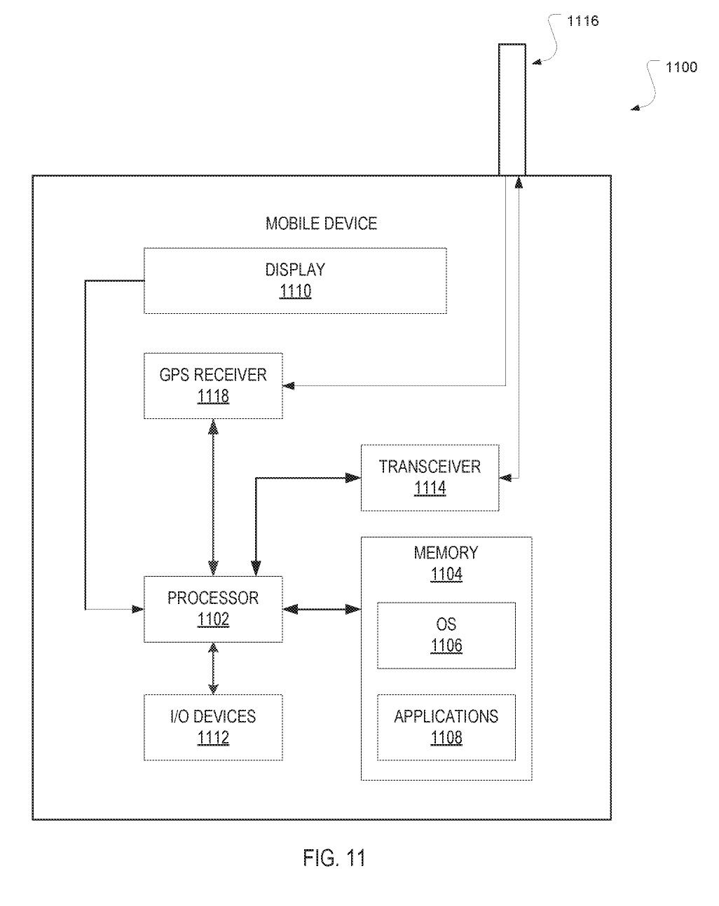

FIG. 11 is a block diagram illustrating a mobile device 1100, according to an example embodiment. The mobile device 1100 can include a processor 1102. The processor 1102 can be any of a variety of different types of commercially available processors suitable for mobile devices 1100 (for example, an XScale architecture microprocessor, a microprocessor without interlocked pipeline stages (MIPS) architecture processor, or another type of processor). A memory 1104, such as a random access memory (RAM), a flash memory, or another type of memory, is typically accessible to the processor 1102. The memory 1104 can be adapted to store an operating system (OS) 1106, as well as applications 1108, such as a mobile location-enabled application that can provide location-based services (LBSs) to a user. The processor 1102 can be coupled, either directly or via appropriate intermediary hardware, to a display 1110 and to one or more input/output (I/O) devices 1112, such as a keypad, a touch panel sensor, and a microphone. Similarly, in some embodiments, the processor 1102 can be coupled to a transceiver 1114 that interfaces with an antenna 1116. The transceiver 1114 can be configured to both transmit and receive cellular network signals, wireless data signals, or other types of signals via the antenna 1116, depending on the nature of the mobile device 1100. Further, in some configurations, a global positioning system (GPS) receiver 1118 can also make use of the antenna 1116 to receive GPS signals.

### EXAMPLES

In one example embodiment, a computerized method for accessing information comprises: obtaining a cost structure for a product from a database; obtaining a price trend model from a price trend model repository of the database, the price trend model configured to estimate a cost for one or more items of the cost structure; computing, using a hardware processor, an item cost for each of the one or more items of the cost structure using the price trend model; and computing, using the hardware processor, a cost of the product based on the item costs. The computerized method may further comprise selecting an extractor based on a target certainty, a selected cost driver, a selected data source, or a target cost variant; generating the price trend model and corresponding coefficients based on historical pricing information, pricing information from a web site, pricing information from a third-party or service provider, pricing information from an expert, or pricing information from public resources; and selecting the price trend model based on a target certainty, a selected cost driver, a selected data source, or a target cost variant. The model type of the price trend model may be a linear approximation and may be stored as a time-series model. The price trend model may be defined for a specified item of the cost structure, a specified group of items of the cost structure, a type of item of the cost structure, or all items of the cost structure. The computing of the cost of the product based on the item costs may be performed for a plurality of variants.

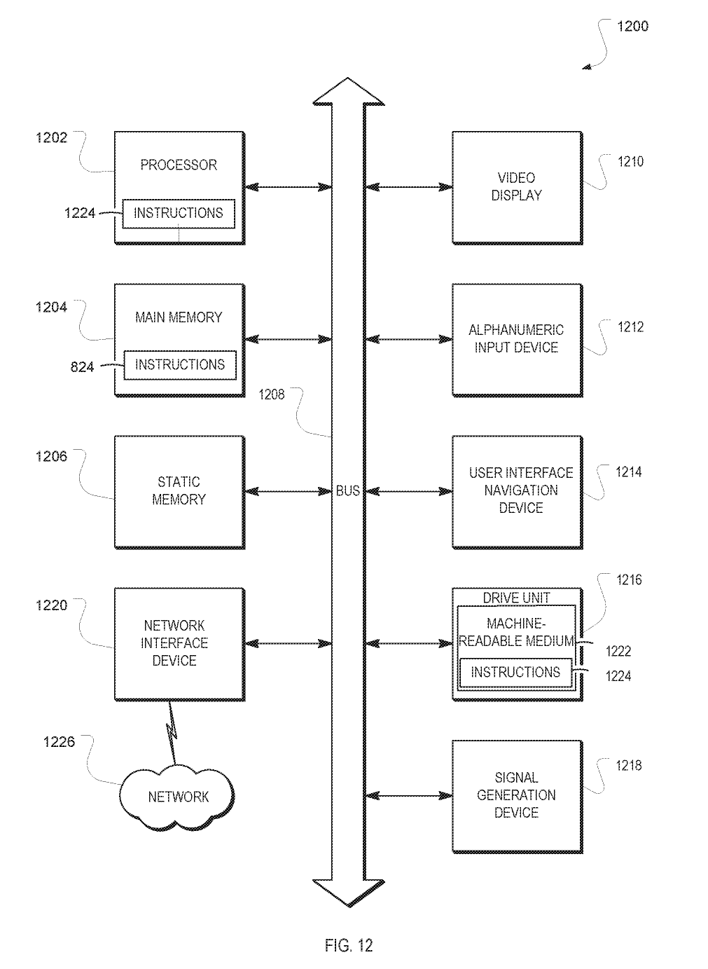

FIG. 12 is a block diagram of a computer processing system 1200 within which a set of instructions 1224 may be executed for causing a computer to perform any one or more of the methodologies discussed herein. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment.

In addition to being sold or licensed via traditional channels, embodiments may also, for example, be deployed as software-as-a-service (SaaS), by an application service provider (ASP), or by utility computing providers. The computer may be a server computer, a personal computer (PC), a tablet PC, a personal digital assistant (PDA), a cellular telephone, or any processing device capable of executing a set of instructions 1224 (sequential or otherwise) that specify actions to be taken by that device. Further, while only a single computer is illustrated, the term “computer” shall also be taken to include any collection of computers that, individually or jointly, execute a set (or multiple sets) of instructions 1224 to perform any one or more of the methodologies discussed herein.

The example computer processing system 1200 includes a processor 1202 (e.g., a central processing unit (CPU), a graphics processing unit (GPU), or both), a main memory 1204, and a static memory 1206, which communicate with each other via a bus 1208. The computer processing system 1200 may further include a video display 1210 (e.g., a plasma display, a liquid crystal display (LCD), or a cathode ray tube (CRT)). The computer processing system 1200 also includes an alphanumeric input device 1212 (e.g., a keyboard), a user interface navigation device 1214 (e.g., a mouse and/or touch screen), a drive unit 1216, a signal generation device 1218 (e.g., a speaker), and a network interface device 1220.

The drive unit 1216 includes a machine-readable medium 1222 on which is stored one or more sets of instructions 1224 and data structures embodying or utilized by any one or more of the methodologies or functions described herein. The instructions 1224 may also reside, completely or at least partially, within the main memory 1204, the static memory 1206, and/or the processor 1202 during execution thereof by the computer processing system 1200, the main memory 1204, the static memory 1206, and the processor 1202 also constituting tangible machine-readable media 1222.

The instructions 1224 may further be transmitted or received over a network 1226 via the network interface device 1220 utilizing any one of a number of well-known transfer protocols (e.g., Hypertext Transfer Protocol (HTTP)).

While the machine-readable medium 1222 is shown, in an example embodiment, to be a single medium, the term “machine-readable medium” should be taken to include a single medium or multiple media (e.g., a centralized or distributed database, and/or associated caches and servers) that store the one or more sets of instructions 1224. The term “machine-readable medium” shall also be taken to include any medium that is capable of storing, encoding, or carrying a set of instructions 1224 for execution by the computer and that cause the computer to perform any one or more of the methodologies of the present application, or that is capable of storing, encoding, or carrying data structures utilized by or associated with such a set of instructions 1224. The term “machine-readable medium” shall accordingly be taken to include, but not be limited to, solid-state memories and optical and magnetic media.

While the embodiments of the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method for accessing information, the method comprising:
obtaining a cost structure for a product from a database;
obtaining a price trend model from a price trend model repository of the database, the price trend model configured to estimate a cost for one or more items of the cost structure;
computing, using a hardware processor, an item cost for each of the one or more items of the cost structure using the price trend model; and
computing, using the hardware processor, a cost of the product based on the item costs.

2. The computerized method of claim 1, further comprising selecting an extractor based on a target certainty, a selected cost driver, a selected data source, or a target cost variant.

3. The computerized method of claim 1, further comprising generating the price trend model and corresponding coefficients based on historical pricing information, pricing information from a web site, pricing information from a third-party or service provider, pricing information from an expert, or pricing information from public resources.

4. The computerized method of claim 1, wherein a model type of the price trend model is a linear approximation.

5. The computerized method of claim 1, wherein the price trend model is stored as a time-series model.

6. The computerized method of claim 1, further comprising selecting the price trend model based on a target certainty, a selected cost driver, a selected data source, or a target cost variant.

7. The computerized method of claim 1, wherein the price trend model is defined for a specified item of the cost structure, a specified group of items of the cost structure, a type of item of the cost structure, or all items of the cost structure.

8. The computerized method of claim 1, wherein the computing of the cost of the product based on the item costs is performed for a plurality of variants.

9. An apparatus comprising:
one or more hardware processors;
memory to store instructions that, when executed by the one or more hardware processors perform operations comprising:
obtaining a cost structure for a product from a database;
obtaining a price trend model from a price trend model repository of the database, the price trend model configured to estimate a cost for one or more items of the cost structure;
computing an item cost for each of the one or more items of the cost structure using the price trend model; and
computing a cost of the product based on the item costs.

10. The apparatus of claim 9, the operations further comprising selecting an extractor based on a target certainty, a selected cost driver, a selected data source, or a target cost variant.

11. The apparatus of claim 9, the operations further comprising generating the price trend model and corresponding coefficients based on historical pricing information, pricing information from a web site, pricing information from a third-party or service provider, pricing information from an expert, or pricing information from public resources.

12. The apparatus of claim 9, wherein a model type of the price trend model is a linear approximation.

13. The apparatus of claim 9, wherein the price trend model is stored as a time-series model.

14. The apparatus of claim 9, the operations further comprising selecting the price trend model based on a target certainty, a selected cost driver, a selected data source, or a target cost variant.

15. The apparatus of claim 9, wherein the price trend model is defined for a specified item of the cost structure, a specified group of items of the cost structure, a type of item of the cost structure, or all items of the cost structure.

16. The apparatus of claim 9, wherein the computing of the cost of the product based on the item costs is performed for a plurality of variants.

17. A non-transitory machine-readable storage medium comprising instructions, which when implemented by one or more machines, cause the one or more machines to perform operations comprising:
obtaining a price trend model from a price trend model repository of the database, the price trend model configured to estimate a cost for one or more items of the cost structure;
computing an item cost for each of the one or more items of the cost structure using the price trend model; and
computing a cost of the product based on the item costs.

18. The non-transitory machine-readable storage medium of claim 17, the operations further comprising selecting an extractor based on a target certainty, a selected cost driver, a selected data source, or a target cost variant.

19. The non-transitory machine-readable storage medium of claim 17, the operations further comprising generating the price trend model and corresponding coefficients based on historical pricing information, pricing information from a web site, pricing information from a third-party or service provider, pricing information from an expert, or pricing information from public resources.

20. The non-transitory machine-readable storage medium of claim 17, the operations further comprising selecting the price trend model based on a target certainty, a selected cost driver, a selected data source, or a target cost variant.
